(19) United States
(12) Patent Application Publication
(10) Pub. No.: US 2019/0353151 A1
(43) Pub. Date: Nov. 21, 2019

(54) ELECTRIC AIR PUMP

(71) Applicant: Chien-Yeh Chang, Taichung City (TW)

(72) Inventor: Chien-Yeh Chang, Taichung City (TW)

(73) Assignee: METALLICA INTERNATIONAL CO., LTD, Taichung City (TW)

(21) Appl. No.: 16/218,812

(22) Filed: Dec. 13, 2018

(30) Foreign Application Priority Data
May 18, 2018 (TW) 107206583

(51) Int. Cl. F04B 35/04; H01R 24/62; F04B 39/12

(52) U.S. Cl. CPC F04B 35/04; H01R 24/76; F04B 39/121; H01R 24/62

(57) ABSTRACT

An electric air pump includes a casing including an interior space; a pumping mechanism disposed in the space and including a driving device, a reciprocating piston driven by the driving device for compressing air, and an outlet being in fluid communication with the reciprocating piston; an on/off switch is disposed on the casing and including a switch contact configured to electrically connect to the driving device or not; and a USB receptacle disposed on the casing and electrically connected to the switch contact.

### BACKGROUND OF THE INVENTION

### 1. Field of the Invention

The invention relates to air pumps and more particularly to an electric air pump.

### 2. Description of Related Art

A conventional electric air pump comprises an electrically operated air compressor; means for driving a compressor from the vehicle's electrical supply; an outlet lien from the compressor to a vehicle tire; a pressure gauge for reading the pressure in the outlet line, the pressure gauge including a dial and a moving indicator to indicate instantaneous pressure; a pointer movably mounted on the pressure gauge and including a tip to be aligned upon movement of the pointer to a predetermined chosen final pressure; a light emitter carried by the pointer to illuminate the area of the dial; an enclosure within the pointer disposed with an opening for the passage of light reflected from the dial into the enclosure, the opening being positioned close to the path of movement of the moving indicator so that the indicator substantially obscures the opening when the indicator points to the chosen final pressure, the opening being additionally positioned so as to prevent the direct passage of light from the light emitter into the enclosure; a photoelectric sensor in the enclosure for detecting the level of light entering the disclosure through the opening, and for disposing an output signal when the light level is reduced by the alignment of the moving indicator with the opening; and means for deactivating the compressor when the photoelectric sensor disposes the output signal upon the alignment of the indicator with the chosen final pressure.

While the device enjoys its success in the market, continuing improvements in the exploitation of electric air pump of this type are constantly being sought.

### SUMMARY OF THE INVENTION

It is therefore one object of the invention to dispose an electric air pump comprising a casing including an interior space; a pumping mechanism disposed in the space and including a driving device, a reciprocating piston driven by the driving device for compressing air, and an outlet being in fluid communication with the reciprocating piston; an on/off switch is disposed on the casing and including a switch contact configured to electrically connect to the driving device or not; and a USB receptacle disposed on the casing and electrically connected to the switch contact.

The above and other objects, features and advantages of the invention will become apparent from the following detailed description taken with the accompanying drawings.

### BRIEF DESCRIPTION OF THE DRAWINGS

FIG. 1 is a perspective view of an electric air pump according to the invention with a USB plug being ready to insert into a USB receptacle of the electric air pump;

FIG. 2 is an exploded view of FIG. 1;

FIG. 3 is a perspective view of the electric air pump with the cover removed; and

FIG. 4 is a front view of FIG. 1 with the USB plug inserted into the USB receptacle of the electric air pump.

### DETAILED DESCRIPTION OF THE INVENTION

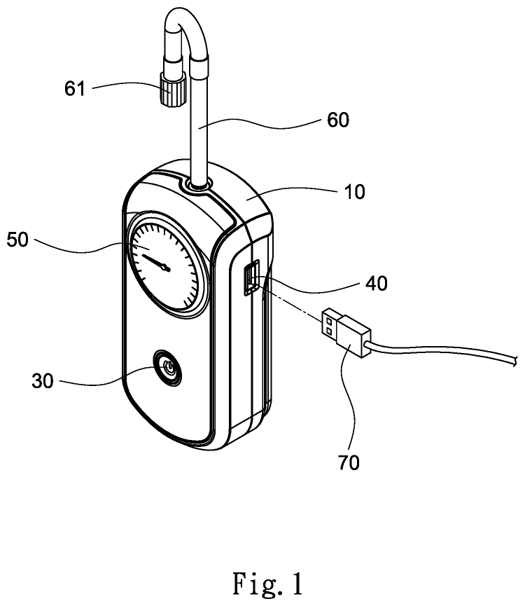

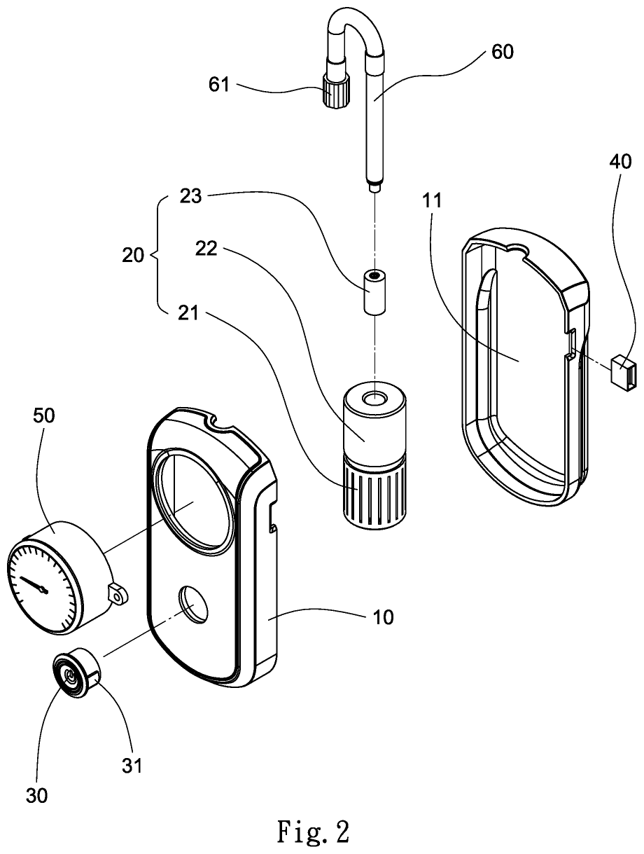

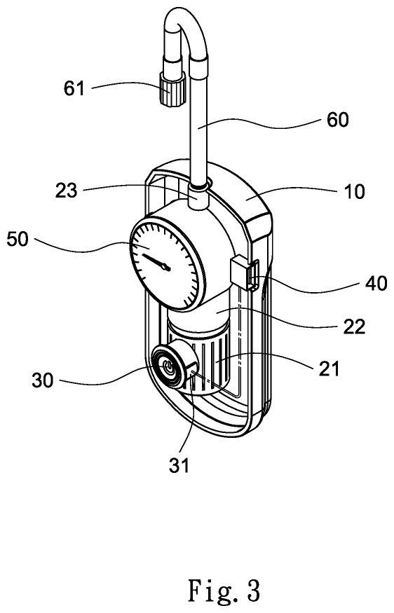

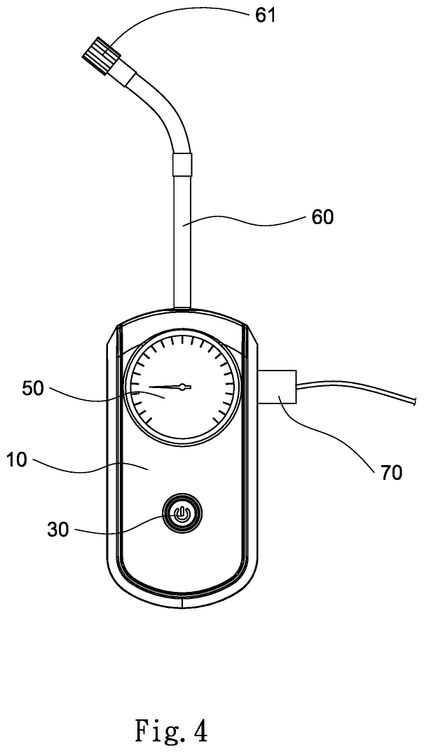

Referring to FIGS. 1 to 4, an electric air pump in accordance with the invention comprises the following components as discussed in detail below.

A casing 10 includes an interior space 11.

A pumping mechanism 20 is disposed in the space 11 and includes a driving device (e.g., electric motor) 21, a reciprocating piston 22 driven by the electric motor 21 for compressing air, and an outlet 23 for supplying the compressed air from the piston 22 to a next stage.

An on/off switch (e.g., push-button switch) 30 is disposed on a front surface of the casing 10 and includes a switch contact 31 electrically connected to the driving device 21 or not.

A Universal Serial Bus (USB) receptacle 40 is disposed on one side of the casing 10 and electrically connected to the switch contact 31.

A pressure gauge 50 is disposed on a front surface of the casing 10 and in fluid communication with the outlet 23. Thus, the pressure gauge 50 can measure pressure of the compressed air passing through the outlet 23.

A supply pipe 60 has one end connected to the outlet 23 and the other end formed as an adapter 61 which is adapted to attach to an object (e.g., basketball or pneumatic tire) to be inflated.

In an inflating operation, a user may insert a USB plug 70 into the USB receptacle 40 and then press the on/off switch 30. Thus, electricity is supplied from the USB plug 70 to the driving device 21 via the USB receptacle 40 and the switch contact 31. Further, the driving device 21 activates to quickly move the piston 22 back and forth. As such, compressed air is transmitted from the piston 22 to the supply 60 via the outlet 23. As an end, an object (e.g., a basketball) attached to the adapter 61 is inflated.

While the invention has been described in terms of preferred embodiments, those skilled in the art will recognize that the invention can be practiced with modifications within the spirit and scope of the appended claims.

What is claimed is:

1. An electric air pump, comprising:
a casing including an interior space;
a pumping mechanism disposed in the space and including a driving device, a reciprocating piston driven by the driving device for compressing air, and an outlet being in fluid communication with the reciprocating piston;
an on/off switch is disposed on the casing and including a switch contact configured to electrically connect to the driving device or not; and
a Universal Serial Bus (USB) receptacle disposed on the casing and electrically connected to the switch contact.

2. The electric air pump of claim 1, further comprising a supply pipe having one end connected to the outlet, the supply pipe including an adapter at the other end.

3. The electric air pump of claim 1, further comprising a pressure measurement device disposed on the casing and being in fluid communication with the outlet.

4. The electric air pump of claim 3, wherein the pressure measurement device is a pressure gauge.
